(19) United States
(12) Patent Application Publication
(10) Pub. No.: US 2006/0109840 A1
(43) Pub. Date: May 25, 2006

(54) Method for providing advanced services for traditional PSTN residential endpoints

(76) Inventor: Guy J. Zenner, Northbrook, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/282,512

(22) Filed: Nov. 18, 2005

Related U.S. Application Data
(60) Provisional application No. 60/629,256, filed on Nov. 18, 2004.

(51) Int. Cl. H04L 12/66

(52) U.S. Cl. 370/356

(57) ABSTRACT

The present invention provides a method for providing advanced services to traditional PSTN residential endpoints. An end office routes a call request to an application server. The application server receives the call request and routes the call request to the PSTN residential endpoint.

### CROSS-REFERENCE TO RELATED APPLICATION

This application claims the benefit of Provisional Application Ser. No. 60/629,256, filed Nov. 18, 2004.

### FIELD OF THE INVENTION

The present invention relates generally to communication systems, and more particularly to providing services to traditional PSTN residential endpoints.

### BACKGROUND OF THE INVENTION

Traditional PSTN copper loop residential endpoints provide telephony service to subscribers. One problem with traditional residential subscribers is the provision of advanced services to the subscribers.

One method proposed to solve this problem involved either transitioning end offices into line gateways or introducing new line gateways to provide new services for traditional endpoints. However, there were several issues with that approach. First, the cost to make changes in every end office to either convert the existing end office or replace the end office with a new line gateway was very high. Second, if only certain offices could be evolved to line gateways, and other vendors do not support this transition, there would be issues surrounding ubiquity and service provider ability. Third, most traditional services will work in a way that has very similar user interactions with the existing PSTN model, so that users get those traditional services in a familiar way, as well as advanced services for the new telephony application server.

Cost has been a major factor in evolving the PSTN subscriber base towards more advanced converged services. Therefore, a need exists for a method of providing advanced services to traditional endpoints.

### BRIEF SUMMARY OF THE INVENTION

The present invention provides a method for providing cost-effective services for traditional endpoints. This does not require any movement of the subscriber's loop or any changes at the customer's premise.

In the case of a call origination, a user originates a call from the PSTN end office to a new application server. The call origination includes a special line class code or digit analysis selector with unique dialing plan and routing algorithms. The call origination also can include special handling for the “star code” (*) that needs to be transmitted through the network. Further, the call origination can include the assignment on four key features in the end office, message waiting, caller ID, 3-way calling and call waiting. The call origination can also include routing in the network for all the user's calls to be properly routed to the new application server.

In the case of a call termination, a call to the user is processed while the application server provides the user's terminating services. Users moving to the new service maintain their original directory number. This number is “ported” through standard Local Number Portability (LNP) mechanisms to be owned by the new telephony application server. Because the user's directory number is ported to the new telephony application server, a mechanism is used to contact that user through the PSTN. In accordance with an exemplary embodiment of the present invention, a common exchange is used to uniquely identify a group of DNs (directory numbers) that are assigned to be contact numbers for this service. The group of DNs assigned as contact numbers, possibly an entire exchange specifically assigned for this purpose, are each ported, preferably via the LNP function, to point via the Local Routing Number (LRN) to the correct end office to reach the user. This separation of contact DNs allows for clear and easier management and recognition capabilities in the service provider network.

For both originations and terminations, the new telephony application server preferably performs a mapping of actual DN to a “contact DN” that is used by the network to identify and contact the user.

### BRIEF DESCRIPTION OF THE SEVERAL VIEWS OF THE DRAWINGS

FIG. 1 depicts a communication system in accordance with an exemplary embodiment of the present invention.

### DETAILED DESCRIPTION OF THE INVENTION

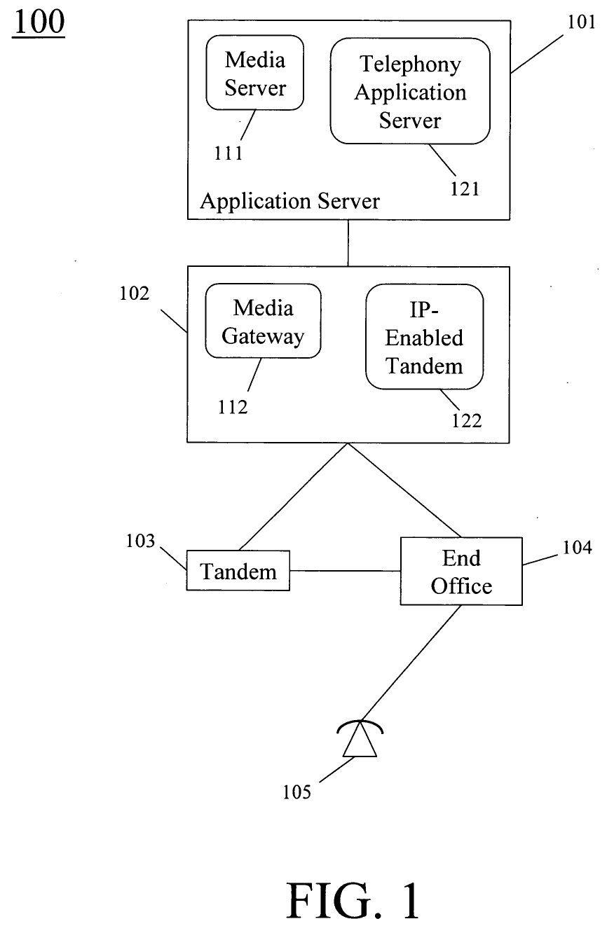

FIG. 1 depicts a communication system 100 in accordance with an exemplary embodiment of the present invention. Communication system 100 preferably includes an application server 101, a mechanism to convert from TDM to IP (e.g. Media Gateway Controller and Media Gateway) 102, Tandem 103, End Office 104, and Customer Premises Equipment (CPE) 105.

Application Server 101 includes media server 111 and telephony application server 121. Application Server 101 is connected to mechanism to convert from TDM to IP (e.g. Media Gateway Controller and Media Gateway) 102 via an interface, preferably utilizing a SIP protocol.

Telephony application server 121 provides subscriber features. In addition, telephony application server 121 provides billing features, Communications Assistance for Law Enforcement Act (CALEA) features, and e911 functionality. In an exemplary embodiment, telephony application server 121 converts XXX(XY) to XY Codes. Telephony application server 121 also provides dual ported DN mapping.

The mechanism to convert TDM to IP 102 preferably includes Media Gateway (MGW) 112 or IP-Enabled Tandem 122. The mechanism to convert TDM to IP 102 provides PSTN/SIP interworking. The mechanism to convert TDM to IP 102 also provides routing set up for directory numbers in application server 101. IP 102 is preferably used to route the Local Routing Number (LRN) to application server 101 for ported DNs. In addition, IP 102 routes to application server 101, preferably over a SIP-based connection, based on prefixed digits or a special talkgroup (TG). The prefixed digits are preferably from EO 104.

Tandem 103 includes a special TG between EO 104 and IP-Enabled Tandem 122. In a further exemplary embodiment, all calls for application server 101 from end office 104 have prefixed digits.

End Office 104 preferably sets up CPE 105 as a POTS line. In an exemplary embodiment, the POTS line is a ported contact DN. The features preferably assigned include message waiting, call waiting, caller ID, caller name, and three way calling. In accordance with an exemplary embodiment, there is a special DAS for advanced residential POTS line, including routing all calls to tandem 103 or translating XY to XXX(XY).

CPE 105 is a phone utilized for placing and receiving calls within communication system 100.

An exemplary embodiment of the present invention comprises several sub-components. In a first exemplary embodiment, digit analysis and routing algorithms between end office 104 and tandem 103 to route calls from the traditional endpoint to tandem 103 to recognize calls from these endpoints getting services from IMS so that calls from these users can be connected to a next generation application server. Further, an exemplary embodiment provides the ability to transport a “*” digit, since normal SS7 signaling does not support transporting a “*” digit, which is used for various subscriber special dialing codes. In accordance with an exemplary embodiment, unique digits are used to represent a “*” code to the feature server. This is preferably done by using EO digit analysis and translations to delete the “*” digit and insert the unique prefix. This unique prefix is recognized at application server 101 to indicate that “*” request.

The present invention also provides a specific set of features that are assigned to an endpoint in the end office. The features preferably include message waiting, caller ID, three-way calling, and call waiting. These features are preferably applied by end office 104. All other subscriber features are preferably derived from the feature server.

An exemplary embodiment of the present invention also provides a “dual-ported DN” feature. Users moving to the new service preferably maintain their original directory number. This number is “ported” through standard Local Number Portability (LNP) mechanisms to be owned by the new telephony application server. This is preferably accomplished using an LRN associated with the SS/MG function, which in turn, routes the requests for that user over IP to the new telephony application server.

Because the user's directory number is ported to the new telephony application server, a mechanism is used to contact that user through the PSTN. An exemplary embodiment of the present invention includes the use of a common exchange, preferably defined by the service provider, to uniquely be used as a group of DNs that are assigned to be contact numbers for this service. The exchange of contact DNs are each ported, via the LNP function, to point via the Local Routing Number (LRN) to the correct end office to reach the user. This separation of contact DNs allows for clear and easier management and recognition capabilities in the service provider network.

The present invention thereby provides a plurality of applications, such as User self management, preferably via a web portal and/or voice portal. The present invention also provides Unified Messaging, with a single mailbox for voice mail, email etc.—individual and family—for wireline and wireless access.

The present invention also provides Call Logs, such as Single call logs for incoming calls, outgoing calls, missed calls for individual and family and for wireline & wireless. The present invention provides Call Notification, the Notification of an incoming call with Caller ID and Calling Name and new Voice Mail/Email Indication.

The present invention also provides Personalized Phone Set Management, such as Configure Features, Hot Keys, Display, etc. from a web portal and a Personal Address Book that allows users to create and edit lists of contacts and to specify how contacts will reach them. The present invention also provides Calendar Coordination, which is the ability to share calendar with friends and family.

The present invention also provides Rapid Dialing, such as Speed Dial, Click-to-Call, Click-to-Transfer, Click-to-Conference/Add, Click-from-Web and Instant Messaging, which is the ability to have two-way real-time text-based Instant Messaging using a Buddy List.

The present invention provides a Personal and Family Numbers—Several Devices feature, which provides a single reach and billing phone number for both incoming and outgoing calls and family phone(s) respond to many numbers including wireless numbers, which is similar to Shared Call Appearance.

The present invention also provides a One Device—One Number feature. In accordance with this feature, the end user has a single phone number and a single handset for wireline and wireless. This provides better voice quality, convenience, and more features to the user. Further, a dual-mode Wi/Fi/Cellular handset that uses Voice over Internet Protocol (VoIP) over WiFi when indoor and GSM/UMTS when outdoor is facilitated.

The present invention also provides a One Device—Several Numbers feature. A single phone can activate multiple phone numbers simultaneously e.g. for personal/work, personal/family. Further, an end user can turn on or turn off at will the phone numbers that will work on the phone and thus control their accessibility wherever they are.

The present invention also provides a Context Sensitive Call Routing. The end users incoming calls are routed based on users preference—e.g. Calling Party, Time of Day, Current Usage, etc. The end users outgoing calls are routed based on access restrictions, such as Long Distance, International, 900, etc.

The present invention also provides a Presence & Availability Based Call Routing feature, in which the end users incoming calls are routed based on presence—cell phone is turned on, logged into PC and availability—idle, busy, etc. The present invention also provides a Local Presence feature, in which the end user can have phone number(s) from different area codes, which saves on long distance calls for friends and family by choosing area codes that are local to them.

While this invention has been described in terms of certain examples thereof, it is not intended that it be limited to the above description, but rather only to the extent set forth in the claims that follow.

I claim:

1. A method for providing advanced services to a PSTN residential endpoint, the method comprising:
performing routing algorithms at an end office to route a call request received at the end office to an application server;
receiving the call request at the application server; and
routing the call request from the application server to the PSTN residential endpoint.

2. A method for providing advanced services to a PSTN residential endpoint in accordance with claim 1, the method further comprising the step of performing digit analysis at the end office.

3. A method for providing advanced services to a PSTN residential endpoint in accordance with claim 2, wherein the end office transmits a “*” digit to the application server.

4. A method for providing advanced services to a PSTN residential endpoint in accordance with claim 3, wherein the step of transmits a “*” digit to the application server comprises transmitting a predetermined unique prefix to the application server to represent the “*” digit.

5. A method for providing advanced services to a PSTN residential endpoint in accordance with claim 1, wherein the end office provides a set of call features for the PSTN residential endpoint.

6. A method for providing advanced services to a PSTN residential endpoint in accordance with claim 1, wherein the application server provides a set of call features for the PSTN residential endpoint.

7. A method for providing advanced services to a PSTN residential endpoint in accordance with claim 1, wherein the step of performing routing algorithms at an end office to route a call request received at the end office to an application server comprises utilizing a common exchange to route the call request.

8. A method for originating a call from a PSTN residential endpoint, the method comprising:
originating a call request from the PSTN residential endpoint to the PSTN, wherein the call request includes a special line class code; and
forwarding the call request from the PSTN to an application server based at least in part upon the special line class code.

9. A method for originating a call from a PSTN residential endpoint in accordance with claim 8, the method further comprising the step of handling the star code “*”.

10. A method for originating a call from a PSTN residential endpoint in accordance with claim 8 wherein the call request includes an assignment of a call feature.

11. A method for originating a call from a PSTN residential endpoint in accordance with claim 10, wherein the call feature is a message waiting feature.

12. A method for originating a call from a PSTN residential endpoint in accordance with claim 10, wherein the call feature is a caller ID feature.

13. A method for originating a call from a PSTN residential endpoint in accordance with claim 10, wherein the call feature is a three-way calling feature.

14. A method for originating a call from a PSTN residential endpoint in accordance with claim 10, wherein the call feature is a call waiting feature.

15. A method for originating a call from a PSTN residential endpoint in accordance with claim 8, wherein the application server performs a mapping of an actual directory number to a contact directory number, and wherein the contact directory number is used to identify the PSTN residential endpoint.

16. A method for routing a call at to a PSTN residential endpoint, the method comprising:
receiving a call request for a PSTN residential endpoint at a network;
routing the call request to an application server; and
routing the call request to the PSTN residential endpoint via the PSTN.

17. A method for routing a call at to a PSTN residential endpoint in accordance with claim 16, wherein the PSTN residential endpoint is initially registered with the PSTN utilizing a first directory number, wherein the PSTN residential endpoint moves to the application server and has a second directory number, and wherein the first directory number is assigned as the second directory number.

18. A method for routing a call at to a PSTN residential endpoint in accordance with claim 17, wherein the first directory number is ported through Local Number Portability (LNP) mechanisms to the application server.

19. A method for routing a call at to a PSTN residential endpoint in accordance with claim 16, wherein the call request comprises a phone number including an exchange, and wherein the step of routing the call request to the application server comprises routing the call request to the application server based at least in part upon the exchange.

20. A method for routing a call at to a PSTN residential endpoint in accordance with claim 16, wherein the step of routing the call request to the PSTN residential endpoint via the PSTN comprises mapping an actual directory number from a contact directory number received in the call request.
